(19) United States
(12) Patent Application Publication
(10) Pub. No.: US 2006/0125774 A1
(43) Pub. Date: Jun. 15, 2006

(54) Lighting device, liquid crystal display device, mobile terminal device and its controlling method

(75) Inventor: Eitaro Nishigaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 11/295,460

(22) Filed: Dec. 7, 2005

(30) Foreign Application Priority Data
Dec. 9, 2004 (JP) 356905/2004

(51) Int. Cl. G09G 3/36

(52) U.S. Cl. 345/102

(57) ABSTRACT

A lighting device of backlight type that transmits light of a plurality of light emitting elements from a display section includes a plurality of driving sections that drive the plurality of light emitting elements; and drive switching section, provided between the plurality of driving sections and the plurality of light emitting elements, for switching the drive of the plurality of light emitting elements alternately at every fixed cycle.

### BACKGROUND OF THE INVENTION

1. Field of the Invention

The present invention relates to a lighting device, liquid crystal display device, mobile terminal device and its controlling method, and more particularly relates to a lighting device, liquid crystal display device, mobile terminal device and its controlling method by which unevenness of luminance is improved when light emitting elements as backlight are lit.

2. Description of the Related Art

A liquid display device needs an external light source since the liquid display device itself is not a self-luminous display device. A backlight in a lighting device generally refers to a light source provided on a back surface of the liquid crystal display. Especially, in a transmissive liquid crystal display device, the light source is placed on the back surface. For this reason, this light source is referred to as the backlight.

Conventionally, a cold cathode tube is mainly used as a backlight source. There is also proposed a liquid crystal display device using light emitting diodes (LEDs), which are light emitting elements of red (R), green (G) and blue (B), as a light source, in place of the backlight of the cold cathode tube. In other words, this device is one that displays a color by mixing lights and is called LED backlight.

In order to display for a large image, a high resolution, a high colorfulness and a high definition are required, and thus projection type devices are mainly used. In these devices, a high performance backlight is required to ensure visibility. In the case of the projection type, an incandescent lamp, LED, electroluminescence (EL), a fluorescent lamp, a metal halide lamp, and the like are used as backlight sources. Among these light sources, the present invention relates LED.

One example of such conventional backlight systems is proposed in Japanese Patent Laid-Open No. 2002-373795. Referring to FIG. 1A illustrating the structure of the proposed backlight system, an LED backlight 24 includes a resistor R, a light emitting diode LED 1, and a light emitting diode LED 2. A switching section 23 includes electronic switches SW1 and SW2, and the switch SW1 or SW2 is repeatedly turned on and off alternately by a timing signal supplied from a timing control section 25.

One in which the electronic switch SW1 and the light emitting diode LED1 are connected to each other in series and one in which the electronic switch SW2 and the light emitting diode LED2 are connected to each other in series are connected to each other in parallel and the resistor R is connected thereto in series. The timing control section 25 supplies the timing signal to the switch SW1 and switch SW2 every ½ of a fixed time cycle (T/2) to control the switches SW1 and SW2 to be repeatedly turned on and off alternately.

Other example relating to the backlight system is proposed in Japanese Patent No. 3584351. In connection with the backlight system proposed here, there is shown a liquid crystal display device of colored light source type that causes a three-color backlight to be emitted in a time divisional manner to perform full color display. Referring to FIG. 1B, a light emitting region 32 is divided into a plurality of regions 321 to 324. In this document, the following feature is described. Based on recognition that light emission intensity differs for the scanning start region and the scanning end region, each divided light emitting region are different from each other in light transmittance due to the characteristic problem of the liquid crystal panel itself even if the same voltage is applied thereto. As illustrated in FIG. 1B, for the purpose of improving the unevenness of luminance in hypothetically divided display regions 311 to 314, the light emitting region is divided into the plurality of regions and light emission intensity is made different for each divided light emitting region.

Next, assume a backlight unit that includes plural combinations of LEDs as light sources and driving unit for the LEDs. In the case where the technique described in the aforementioned Japanese Patent Laid-Open No. 2002-373795 is applied to this backlight unit, plural switching sections and their driving section are provided. In this case, when there is an output difference between the driving sections, variations in LED luminance occur. Accordingly, variations in luminance also occur in the inner surface of the backlight using the LEDs. However, this document does not disclose anything about its improving method.

Meanwhile, in Japanese Patent No. 3584351, it is described that unevenness of luminance occurs since the scanning start region and the scanning end region are different from each other in light transmittance due to the characteristic problem of the liquid crystal panel itself even if the same voltage is applied thereto. For the purpose of improving the unevenness of luminance, the light emitting region is divided into the plurality of regions and light emission intensity is made different for each divided light emitting region. However, this does not take measures against the unevenness of luminance in each divided light emitting region, resulting in difficulty to provide light emission intensity to each light emitting region in details.

### SUMMARY OF THE INVENTION

Accordingly, an exemplary feature of the present invention is to reduce unevenness of luminance of a backlight caused by unevenness of luminance generated among light emitting elements that is a problem of the aforementioned conventional backlight system.

Namely, the exemplary feature of the present invention is to provide a lighting device, liquid crystal display device, mobile terminal device and its controlling method for which improvement is performed to prevent occurrence of luminance unevenness of a backlight even if there is a capability difference between driving sections that drive individual light emitting elements (for example, LEDs).

A lighting device according to the present invention is a lighting device of backlight type that transmits light of a plurality of light emitting elements from a display section includes a plurality of driving sections that drive the plurality of light emitting elements; and drive switching section, provided between the plurality of driving sections and the plurality of light emitting elements, for switching the drive of the plurality of light emitting elements alternately at every fixed cycle.

Preferably, at least one light-off time is provided within one frame period during which one screen is displayed on the display section and the drive of the light emitting elements is switched within the light-off time.

Preferably, the drive switching section controls the switching of the plurality of light emitting elements alternately using a plurality of drive control signals each having a different timing.

Preferably, the lighting device of the present invention further includes switch signal generating section for supplying a switch signal to the drive switching section, wherein the drive switching section alternately switches the plurality of light emitting elements and the plurality of driving sections respectively to be connected to each other and to adjust an output difference between the driving sections according to a level change from inactive to active in the drive control signal.

Preferably, the drive switching section is a plurality of switches.

Preferably, the plurality of light emitting elements are respectively driven alternately as maintaining a lighting state.

Preferably, the plurality of driving sections drive the plurality of light emitting elements by pulse width modulation (PWM) dimming and the drive switching section switches the drive of the light emitting elements during the light-off time in PWM dimming.

A liquid crystal display device according to the present invention includes a liquid crystal display section, a lighting device of backlight type that transmits light of a plurality of light emitting elements from a display section and that has a plurality of driving sections that drive the plurality of light emitting elements, and drive switching section, provided between the plurality of driving sections and the plurality of light emitting elements, for switching the drive of the plurality of light emitting elements alternately at every fixed cycle.

Preferably, the drive switching section of the lighting device controls the switching, of the plurality of light emitting elements alternately using a plurality of drive control signals each having a different timing.

Preferably, the liquid crystal display device further includes switch signal generating section for supplying a switch signal to the drive-switching section of the lighting device, wherein the drive switching section alternately switches the plurality of light emitting elements and the plurality of driving sections respectively to be connected to each other and to adjust an output difference between the plurality of driving sections according to a level change from inactive to active in the drive control signal.

A mobile terminal device of the present invention includes a liquid crystal display section; and a lighting device of backlight type that transmits light of a plurality of light emitting elements from a display section and that has a plurality of driving sections that drive the plurality of light emitting elements; and drive switching section, provided between the plurality of driving sections and the plurality of light emitting elements, for switching the drive of the plurality of light emitting elements alternately at every fixed cycle.

Preferably, the drive switching section controls the switching of the plurality of light emitting elements alternately using a plurality of drive control signals each having a different timing.

Preferably, the mobile terminal device further includes switch signal generating section for supplying a switch signal to the drive switching section of the lighting device, wherein the drive switching section alternately switches the plurality of light emitting elements and the plurality of driving sections respectively to be connected to each other and to adjust an output difference between the plurality of driving sections according to a level change from inactive to active in the drive control signal.

Preferably, the drive switching section of the lighting device is a plurality of switches and the switch signal generating section of the lighting device is a switch signal generating section.

A method for controlling a lighting device according to the present invention that transmits light of a plurality of light emitting elements from a back surface of a display section includes the lighting device having a plurality of driving sections that drive the plurality of light emitting elements, a plurality of current switching sections provided between the plurality of driving sections and the plurality of light emitting elements, and a switch signal generating section that supplies a switch signal to the current switching section, wherein the steps of alternately switching the plurality of light emitting elements and the plurality of driving sections respectively to be connected to each other by each of the plurality of current switching section according to a level change from inactive to active in the drive control signal and causing sense section to detect light of the light emitting elements lit alternately according to the switching and connection to control switching of emission of the light emitting elements based on the detection result by the current switching section are included.

Preferably, the method of the present invention further includes the step of switching the drive of the light emitting elements by the current switching section at a predetermined fixed cycle and within light-off time.

Preferably, the method of the present invention further includes the step of adjusting an output difference between the driving sections of the light emitting elements by switching the light emitting elements alternately according to a switch signal of the plurality of current switching section each having a different timing.

Preferably, the method of the present invention further includes the luminance unevenness reduction step of adjusting an output difference between the plurality of driving sections by alternately switching the plurality of light emitting elements and the plurality of driving sections to be connected to each other according to a level change from inactive to active in the drive control signal.

Preferably, the method of the present invention further includes the step of adjusting an output difference between the driving sections by alternately switching the plurality of current switching section to be connected to the light emitting elements by the plurality of driving sections according to a level change from inactive to active in the drive control signal.

Preferably, the method of the present invention further includes the step of alternately driving each of the plurality of light emitting elements by at least two or more driving sections according to a level change from inactive to active in the drive control signal.

Preferably, the method of the present invention further includes the step of alternately driving each of the plurality of light emitting elements by the driving sections while maintaining a lighting state according to a level change from inactive to active in the drive control signal.

According to the lighting device of the present invention, the drive switching section alternately switches the drive of the plurality of light emitting elements using the plurality of driving sections at every fixed cycle. This drives the plurality of light emitting elements equally to make it possible to equalize luminance of plural light emitting elements even if there is a difference in drive capability among the plural driving sections.

According to the liquid crystal display device of the present invention,. the drive switching section of the lighting device alternately switches the drive of the plurality of light emitting elements using the plurality of driving sections at every fixed cycle. This drives the plurality of light emitting elements equally to make it possible to equalize luminance of plural light emitting elements even if there is a difference in drive capability among the plural driving sections. Accordingly, it is possible to reduce the unevenness of the display image resulting from the lighting device.

According to the mobile terminal device of the present invention, the drive switching section of the lighting device alternately switches the drive of the plurality of light emitting elements using the plurality of driving sections at every fixed cycle. This drives the plurality of light emitting elements equally to make it possible to equalize luminance of plural light emitting elements even if there is a difference in drive capability among the plural driving sections. Accordingly, it is possible to reduce the unevenness of the display image resulting from the lighting device.

According to the lighting device controlling method of the present invention, the plurality of light emitting elements and the plurality of driving sections are alternately switched to be connected to each other and to detect light of lit by the light emitting elements, so that the switching of the emission of light emitting elements is controlled based on the detection result. This drives the plurality of light emitting elements equally to make it possible to equalize luminance of plural light emitting elements even if there is a difference in drive capability among the plural driving sections.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1A is a block diagram illustrating one example of a conventional backlight system;

FIG. 1B is a schematic view illustrating a divisional state of each of a light emitting region, an LED array, and a liquid crystal panel in connection with the conventional backlight system;

FIG. 2 is a block diagram of a liquid crystal display device on which a lighting device of the present invention is mounted;

FIG. 3 is a block diagram of LED driving sections in the lighting device according to a first exemplary embodiment of the present invention;

FIG. 4 is a timing chart for explaining an operation according to the first exemplary embodiment of the present invention;

FIG. 5 is a block diagram of drive switching sections 163 for driving R(Red)-LEDs when the number of LED driving sections is three according to a second exemplary embodiment of the present invention;

FIG. 6 is a timing chart for explaining an operation according to the second exemplary embodiment of the present invention;

FIG. 7A is an external view of a mobile terminal device into which the main structures of the liquid crystal device of FIG. 2 are incorporated; and

FIG. 7B is a cross-sectional view taken along a line I-I of FIG. 7A.

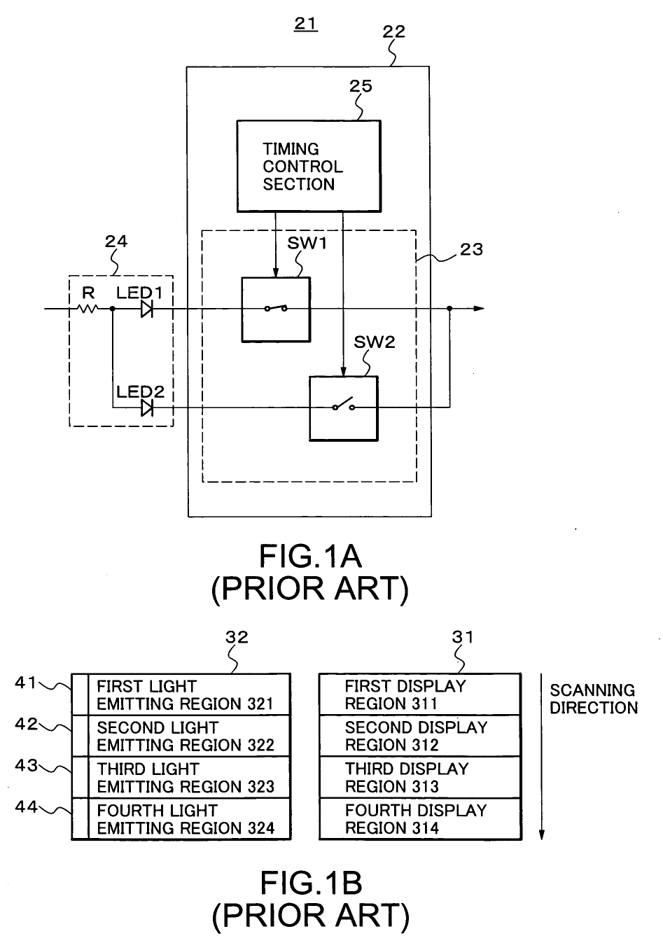

### DETAILED DESCRIPTION OF THE PREFERRED EMBODIMENTS

Next, embodiments of the present invention will be specifically explained with reference to the drawings.

First of all, the following will specifically explain a liquid crystal display device according to a first exemplary embodiment of the present invention with reference to the drawings.

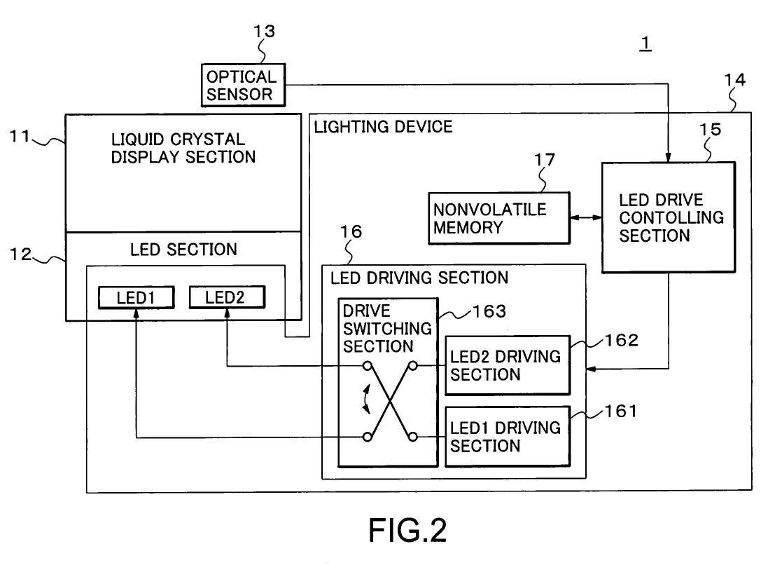

Referring to FIG. 2, a liquid crystal display device 1 includes a liquid crystal display section 11 that is configured with a plurality of liquid crystal display devices, an LED section 12 having light emitting elements for a backlight of liquid crystal display devices, an optical sensor 13, and a lighting device 14 that controls the backlight in response to a detection result of the optical sensor 13.

In other words, the liquid crystal display device 1 has the LED section 12 including plural LED1 and LED2, which are light emitting elements for backlight to transmit light of the light emitting elements arranged on a back surface of the liquid crystal display section 11 from, the liquid crystal display section 11 to make it easy to see the liquid crystal display.

Moreover, the liquid crystal display device 1 has the optical sensor 13 that detects brightness of the backlight from a screen of the liquid crystal display section 11 and the, lighting device 14 that performs optical feedback control to control emission of the LED1 and LED2 of the LED section 12 upon, reception of the detection result of the optical sensor 13.

The lighting device 14 includes an LED drive controlling section 15, an LED driving section 16, and a nonvolatile memory 17. The nonvolatile memory 17 stores an initial value of PWM (Pulse Width Modulation) for LED.

Namely, first of all, an operation, such as how many PWM values should be output or writing and reading of a PWM value for emitting light at a predetermined color temperature, is performed between the nonvolatile memory 17 and the LED drive controlling section 15 when power is turned on.

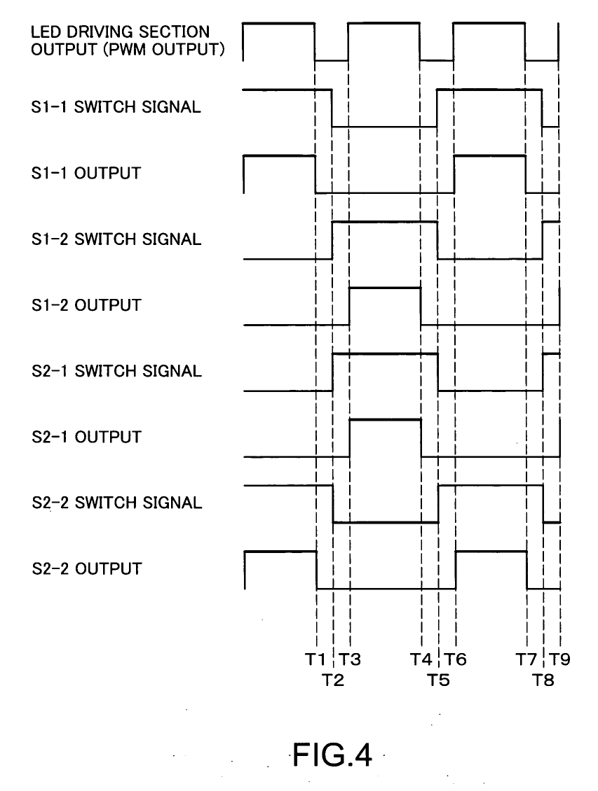

It is assumed that a PWM signal from the LED drive controlling section 15 has the same output timing as an R output of the LED driving section 16 to be described in FIG. 4 and that has a waveform same as that of the R output while having a different level value.

The LED driving section 16 includes a driving section 161 for LED1, a driving section 162 for LED2, and a drive switching section 163. The PWM signal is sent to the respective blocks in common from the LED drive controlling section 15.

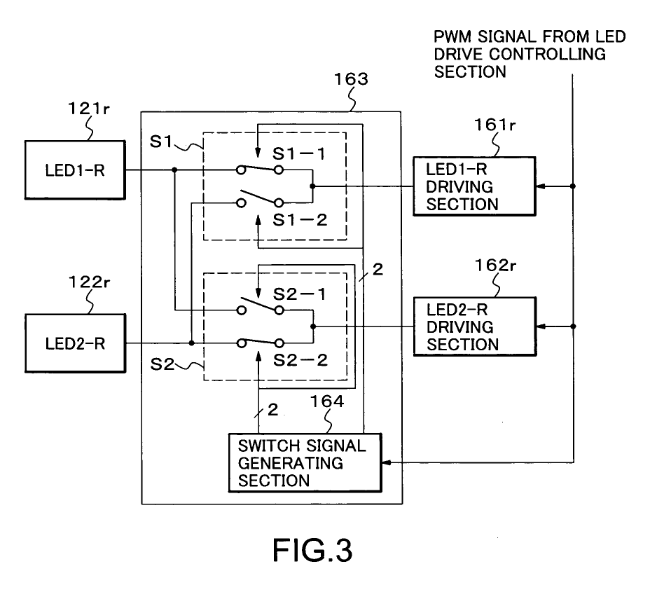

Referring to FIG. 3 that shows a block diagram of the LED driving section 16, a case is shown where the drive of the red (R) LED is switched as one example.

The drive switching section 163 has a switch S1 that selectively switches a driving current from an LED1-R 161r and supplies the current to an LED1-R in order to drive the LED section 12. Moreover, the drive switching section 163 has a switch S2 that selectively switches a driving current from an LED2-R 162r and supplies the current to an LED2-R. Furthermore, the drive switching section 163 has a switch signal generating section 164 that generates a switch control signal for controlling the opening/closing of the switches S1 and S2.

Under control of the switch signal generating section 164, the switch S1 outputs the driving current supplied by the LED1-R driving section 161r to the LED1-R(Red) and the LED2-R(Red) alternately.

Similarly, under control of the switch signal generating section 164, the switch S2 outputs the driving current supplied by the LED2-R driving section 162r to the LED2-R(Red) and the LED1-R(Red) alternately.

In other words, the switch S2 selectively outputs one input current from the corresponding output terminal via two switches S2-1 and S2-2 alternately by the switch signal from the switch signal generating section 164.

A specific operation will be explained with reference to FIG. 3 and FIG. 4 that shows a timing chart for explaining the operation in the first embodiment.

First of all, it is assumed that switch S1-1 is in a high level (hereinafter referred to as on state) of a logical level, switch S1-2 is in a low level (hereinafter referred to as off state) , switch S2-1 is in an off state, and the switch S1-2 is in an on state. The driving current (R output) inputted to the switch S1 from the LED1-R driving section is divided into the switches S1-1 and S1-2 respectively and supplied thereto as a common input. It is assumed that drive capability of the driving current (R output) supplied at this time is a P value.

The PWM output is in an on state until timing T1 and the switch S1-1 is also in an on state, so that the R output drives the LED1-R from the first output terminal using a high-level P value accordingly.

Meanwhile, the R output inputted to the switch S2 from the LED2-R driving section is divided into the switches S2-1 and S2-2 respectively and supplied thereto as a common input similar to the switch S1. It is assumed that drive capability of the driving current (R output) supplied at this time is a Q value that is different from the P value. Although P value may be equal to Q value, the different value is used here.

The PWM output is in an on state until timing T1 as mentioned above, and the switch S2-2 is also in an on state. Therefore, the R output drives the LED2-R from the output terminal of switch S2-2 using a high-level P value.

Next, the PWM output is in an off state until timing T3 after T1. At timing T2 during this time period, the switch S1-1 is changed to off, the switch S1-2 is changed to on, the switch S2-1 is changed to on, and the switch S2-2 is changed to off.

The R output, inputted to the switch S1 from the LED1-R driving section 161r, is supplied to the switches S1-1 and S1-2 as a common input. It is assumed that drive capability of the driving current (R output) supplied at this time is maintained at, for example, a P value. In the present invention, there is, of course, no problem in canceling the level difference even if the P value is changed.

The switch S1-2 is changed to on, so that the R output drives the LED2-R from the output terminal of S1-2 using a high-level P value at timing T3 accordingly.

Meanwhile, the R output, inputted to the switch S2 from the LED2-R driving section 162r, is divided into the switches S2-1 and S2-2 respectively and supplied thereto as a common input similar to the switch S1. It is assumed that drive capability of the driving current (R output) supplied at this time is also a Q value.

The PWM output is in an on state until timing T4 as mentioned above, and the switch S2-1 is also in an on state. Therefore, the R output drives the LED1-R from the output terminal of the switch S2-1 using a high-level Q value.

The aforementioned switching operation is repeated in synchronization with a predetermined PWM output cycle. Namely, regarding the switches S1 and S2, the switch S1 selectively outputs one input current from the corresponding output terminal via two switches S1-1 and S1-2 alternately, using the switch signal from the switch signal generating section 164.

Alternatively, the switch S2 selectively outputs one input current from the corresponding output terminal via two switches S2-1 and S2-2 alternately. In other words, two LEDs are alternately driven by one driving section and one LED is driven by two driving sections alternately.

This switching operation alternately drives the respective LEDs at a fast cycle using the P value and Q value in such a manner to prevent flicker becoming noticeable. The frequency of the switching operation is set about ten times as high as the frame frequency, that is, about 600 Hz. Even if there is a difference in the drive capability (even if the P value and Q value are different from each other), the emission luminance of LEDs becomes equal, and no difference in the drive capability can be observed. Neither switch S1 nor S2 is turned on simultaneously using their internal switches are used. In other words, control is made in such a manner that S1-1 and S2-2 reach the same logical level and the S1-2 and S2-1 reach the same logical level.

In connection with each color of R, G, B, these operations are repeated at a frequency at which no flicker appears, so that the emission luminance of LEDs becomes equal. The backlight unit using these LEDs as light sources can reduce unevenness of luminance of the surface.

The drive switching section 16-3, which is peculiar to the present invention having the switching operation by the switches S1 and S2 as mentioned above, has at least light-off time within one frame period during which one screen is displayed on the display section. The drive of the light emitting element is switched within the light-off time. The frame frequency is several tens Hz, for example, 60 Hz or 70 Hz, and depends on display resolution. In other words, the drive switching section 163 has an operation function to change the switches S1 and S2 during the time when the PWM output of the LED driving section is in the low level of the logical level. For this reason, the drive switching section 163 is switched at high speed, and luminance is thereby equalized and viewed.

Accordingly, in the present invention, since the outputs of the plural LED driving sections are changed to equalize the outputs even if there is the output difference between the plural LED driving sections, it is possible to reduce unevenness of luminance caused by variations in the outputs of the LED driving sections. Moreover, even if there are variations in the output current values of the plural drive power sources, the variations are equalized since the output current values are alternately changed by the plural driving sections, thereby allowing a reduction in unevenness of luminance.

Furthermore, this eliminates the need for making an adjustment to the outputs of the LED driving sections using a luminance meter and the like, thereby contributing to a reduction in cost. Moreover, since the variations are equalized, there is no need of a step for adjusting the variations in the output current of the LED driving sections using an output amount adjusting section such as a volume, etc., thereby contributing to a reduction in production cost.

Still moreover, at least one light-off time is provided within one frame time, and the drive of light emitting element is switched alternately by the plural driving sections within the light-off time at a predetermined fixed cycle. Accordingly, noise caused by switching the drive is not noticeable within one frame display time and no noise erasing circuit is needed.

Next, an explanation will be specifically given of a liquid crystal display device according to a second exemplary embodiment of the present invention with reference to the drawings.

Although the number of LED driving sections is two, that is, LED1 driving sections 161 and 162 in the aforementioned first embodiment, the following will explain that the same effect can be obtained even if the number of LED driving sections and that of LEDs of the LED section 12 are three or more respectively.

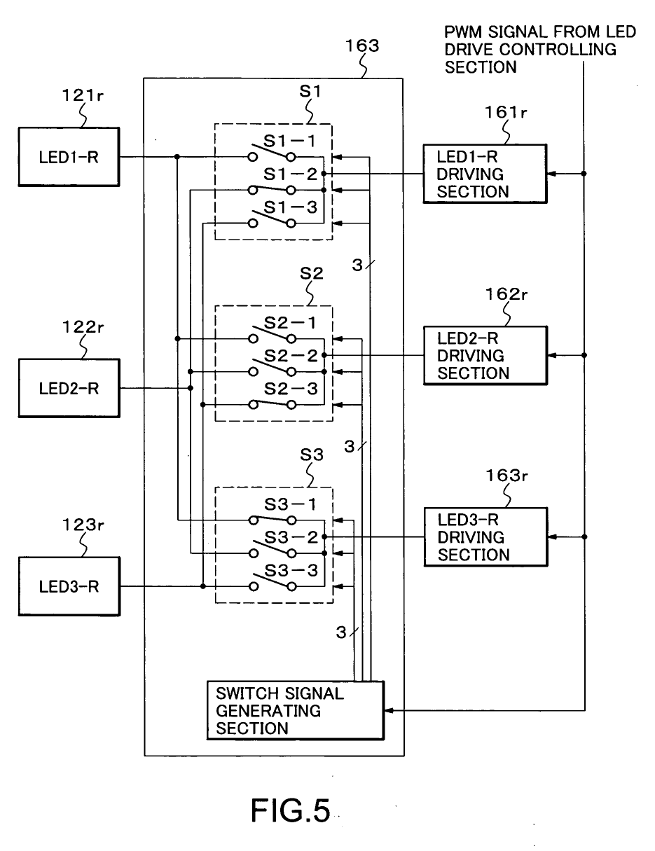

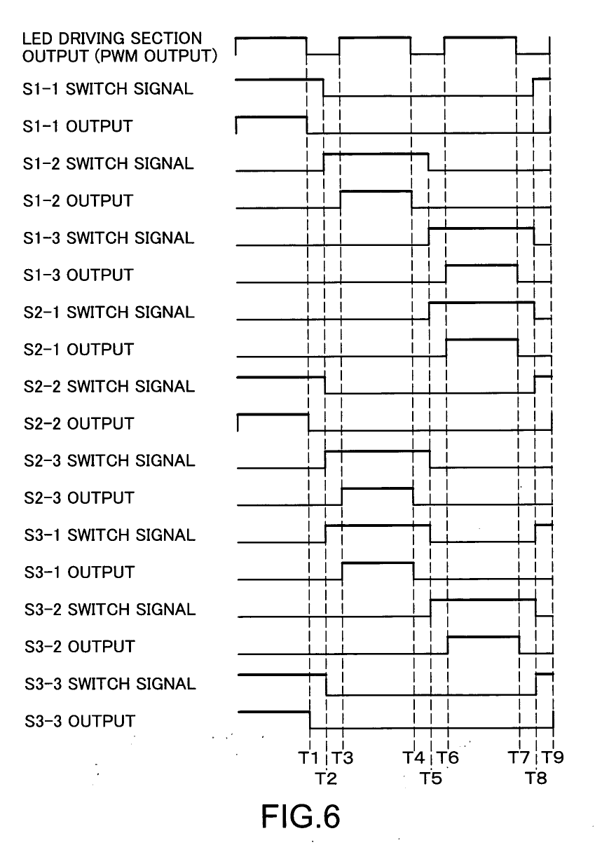

The on and off states of the switches S1, S2, and S3 illustrated in FIG. 5 indicate states between timing T2 to T5 in FIG. 6 described later as one example.

Referring to FIG. 5, the second embodiment differs from the first embodiment in the point that an LED3-R driving section 163r, a switch S3, and an LED3-R of the LED section 12 are added. Namely, the drive switching section 163 includes three switches S1, S2, and S3 and the switch signal generating section 164, and the switches S1, S2 and S3 have three independent outputs for one input. The LED drive controlling section 15 supplies a PWM signal to the LED1-R driving section 161r, LED2-R driving section 162r, and LED3-R driving section 163r in common respectively. Moreover, the opening/closing of the switches S1, S2, and S3 are alternately controlled by the switch signal from the switch signal generating section 164.

A specific operation will be explained with reference to FIG. 5 and FIG. 6 that shows a timing chart for explaining the operation in the second embodiment. The switches S1-1, S1-2, and S1-3 of the switch S1 are respectively controlled in synchronization with the PWM signal by the switch signal from the switch signal generating section 164 in such a manner that these switches are turned on independently of one another without being turned on simultaneously. Similarly, the switches S2 and S3 are also respectively controlled in such a manner that these switches are turned on independently of one another without being turned on simultaneously. Moreover, regarding the switches with the same number among the switches S1, S2 and S3, for example, two or more switches of S1-1, S1-2 and S1-3 are controlled not to be turned on simultaneously.

First, the PWM output is in an on state until timing T1 and the switch S1-1 of the switch S1 is in an on state and other switches S1-2 and S1-3 are in an off state. In the switch S2, the switch S2-2 is in an on state and other switches S2-1 and S2-3 are in an off state. In the switch S3, the switch S3-3 is in an on state and other switches S3-2 and S3-2 are in an off state.

The switch S1-1 is in an on state, so that the driving current (R output) inputted to the switch S1 from the LED1-R driving section 161r is divided into the switches S1-1 to S1-3 respectively and supplied thereto as a common input. It is assumed that drive capability of the driving current (R output) supplied at this time is an R value. The switch S1-1 is also in an on state, so that the R output drives the LED1-R from the output terminal of S1-1 using a high-level R value accordingly.

On one hand, the R output inputted to the switch S2 from the LED2-R driving section 162r is divided into the switches S2-1 and S2-3 respectively and supplied thereto as a common input similar to the switch S1. It is assumed that drive capability of the driving current (R output) supplied at this time is an S value that is different from the R value. Although R value maybe equal to S value, the different value is used here. The PWM output is in an on state until timing T1 and the switch S2-2 is also in an on state, so that the R output drives the LED2-R from the first output terminal of S2-2 using a high-level R value accordingly.

On the other hand, the R output inputted to the switch S3 from the LED3-R driving section 163r is divided into the switches S3-1 to S3-3 respectively and supplied thereto as a common input similar to the switch S1. It is assumed that drive capability of the driving current (R output) supplied at this time is a T value that is different from the S value. Although R value, S value and T value may be equal to each other, the different values are used here respectively. The PWM output is in an on state until timing T1 and the switch S3-3 is also in an on state, so that the R output drives the LED3-R from the output terminal of S3-3 using a high-level R value accordingly.

Next, the PWM output is in an off state until timing T3 after T1. At timing T2 during this time period, the switch S1-1 is changed from on to off, the switch S1-2 is changed from off to on, and the switch S1-3 is maintained in the off state. The switch S2-1 is maintained in the off state, the switch S2-2 is changed from on to off, and the switch S2-3 is changed from off to on. The switch S3-1 is changed from off to on, the switch S3-2 is maintained in the off state, and the switch S3-3 is changed from on to off.

The R output, inputted to the switch S1 from the LED1-R driving section 161r where the PWM output is in an on state until timing T4 after T3, is supplied to the switches S1-1 and S1-2 as a common input. The switch S1-2 is changed to an on state, so that the R output drives the LED2-R from the output terminal of S1-2 using a high-level P value at timing T3 accordingly.

On one hand, the R output inputted to the switch S2 from the LED2-R driving section 162r is divided into the switches S2-1, S2-2, and S2-3 respectively and supplied thereto as a common input similar to the switch S1. The switch S2-3 is changed to an on state, so that the R output drives the LED3-R from the output terminal of S2-3 using a high-level P value at timing T3 accordingly.

On one hand, the R output inputted to the switch S3 from the LED3-R driving section 163r is divided into the switches S3-1, S3-2, and S3-3 respectively and supplied thereto as a common input similar to the switch S1. The switch S3-1 is changed to an on state, so that the R output drives the LED1-R from the output terminal of S3-1 using a high-level P value at timing T3 accordingly.

The PWM output is in an off state until timing T4 to T6. At timing T5 during this time period, the switch S1-1 is maintained in an off state, the switch S1-2 is changed from on to off, and the switch S1-3 is changed from off to on. The switch S2-1 is changed from off to on, the switch S2-2 is maintained in the off state, and the switch S2-3 is changed from on to off. The switch S3-2 is changed from on to off, the switch S3-2 is changed from off to on, and the switch S3-3 is maintained in the off state.

The R output, inputted to the switch S1 from the LED1-R driving section 161r where the PWM output is in an on state until timing T7 after T6, is supplied to the switches S1-1, S1-2, and S1-3 as a common input. The switch S1-3 is changed to an on state, so that the R output drives the LED3-R from the output terminal of S1-3 using a high-level P value at timing T6 accordingly.

On one hand, the R output inputted to the switch S2 from the LED2-R driving section 162r is divided into the switches S2-1, S2-2, and S2-3 respectively and supplied thereto as a common input similar to the switch S1. The switch S2-1 is changed to an on state, so that the R output drives the LED1-R from the output terminal of S2-1 using a high-level P value at timing T6 accordingly.

On one hand, the R output inputted to the switch S3 from the LED3-R driving section is divided into the switches S3-1, S3-2, and S3-3 respectively and supplied thereto as a common input similar to the switch S1. The switch S3-2 is changed to an on state, so that the R output drives the LED2-R from the output terminal of S3-2 using a high-level P value at timing T6 accordingly.

The aforementioned switching operation is repeated in synchronization with a predetermined PWM output cycle.

In the second embodiment, the same effect as the first embodiment can be obtained.

In other words, each of the switches S1 to S3 selectively outputs one input current from the corresponding output terminal via three switches (S1-1 to S1-3, S2-1 to S2-3, or S3-1 to S3-3) alternately using the switch signal from the switch signal generating section 164. Namely, three LEDs are alternately driven by one driving section and one LED is driven by three driving sections alternately.

This switching operation alternately drives the respective LEDs at a fast cycle using R value, S value, and T value even if there is a difference in the drive capability (even if the P value, S value, and T value are different from one another). As a result, the emission luminance of LEDs becomes equal, and no difference is found in the drive capability.

Accordingly, in the case where the number of LED driving sections is n, n switches with one input and n outputs are prepared, allowing the embodiment of the present invention to be structured.

Although the preferred embodiments of the present invention have been explained as mentioned above, the present invention is not limited to the above embodiments, and various changes and applications may be made. For example, although the above first and second embodiments have been explained based on the structure of the semiconductor switch, it is apparent that the present invention may be structured using a semiconductor relay and the like.

Moreover, although the above has explained the case in which LEDs are used as light emitting elements, the present invention may be applied to any case if the lighting device uses the light emitting elements of current drive type. For example, the present invention may be also applied to a case in which organic light emitting elements (OLED) are used as light emitting elements.

Furthermore, in displaying the screen of the liquid crystal display device, the present invention may be applied so that drive current of the driving section may be changed one line by one at a PWM dimming time. In other words, this is the most effective way in terms of the equalization of luminance in the screen since one line is the minimum unit of switching and there is adequate time to switch current during the off time period of the PWM signal.

Moreover, as another example in which the present invention is applied in displaying the screen of the liquid crystal: display device, drive current of the driving section may be switched every plural lines at the time of using a blinking backlight for a moving image. Namely, when the aforementioned present invention is applied to the case in which a large screen has plural LED power sources, luminance in the screen becomes equal to reduce unevenness of luminance due to variations in the amount of current.

Also, when the aforementioned present invention is applied to the case in which plural LED drive power sources are provided in a mobile terminal device having a liquid crystal display screen, luminance in the screen becomes equal to reduce unevenness of luminance due to variations in the amount of current. An embodiment in which the liquid crystal display device shown in FIG. 2 is incorporated into the mobile terminal device will be explained with reference to the drawings.

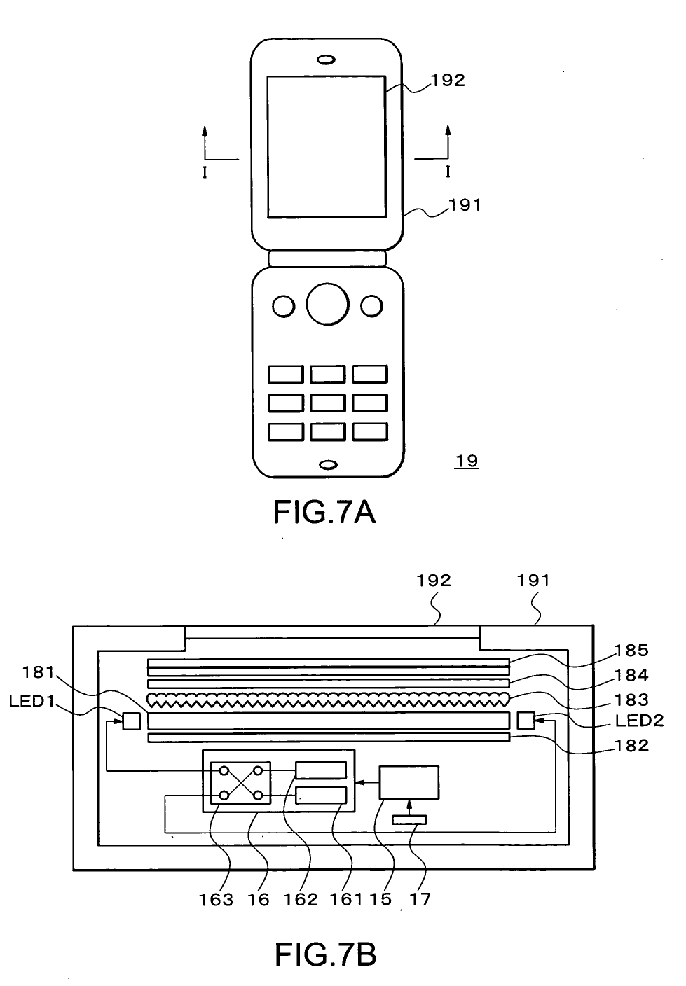

As illustrated in FIG. 7A, such a mobile terminal device 19 includes a housing 192 and a transparent cover section 192 attached to a portion where a liquid crystal display device is incorporated.

“2.2-inch QVGA scan backlight stereoscopic LCD” by Akimasa Yuki presented at the 3DC Conference 2005 in NAGOYA describes a scan backlight in which LEDs as light sources are arranged at both left and right sides of one light-guide plate and a double-sided prism sheet is placed on the light-guide plate. In this case, an image signal for a left eye and an image signal for a right eye are supplied to a liquid crystal panel in a time divisional manner. The left LED is lit during the time when the liquid crystal panel displays the image for a left eye and the right LED is lit during the period when the liquid crystal panel displays the image for a right eye. Such control implements stereoscopic image display without using special glasses.

The following will explain the case in which the present invention is applied to such scan backlight.

As illustrated in FIG. 7B, an LED1 is placed at the left side of a light-guide plate 181 and an LED2 is placed at the right side thereof. A reflection plate 182 for preventing light from leaking from the light-guide plate 181 is placed under the light-guide plate 181. An optical sheet 184 and a double-sided prism sheet 183 are provided between a liquid crystal panel 185 and the light-guide plate 181. Triangular prisms are formed on a surface of the double-sided prism sheet 183 facing the light-guide plate 181. A columnar lenticular lens is formed on a surface of the double-sided prism sheet 183 facing the liquid crystal panel 185. The optical sheet 184 works to supply an emitting light of the double-sided prism sheet 183 to the liquid crystal panel 185 after scattering and concentrating the beam appropriately. In such scan backlight, LED1 and LED2 arranged at both left and right sides of the light-guide plate 181 are turned on and off in a time divisional manner. The outputs of the plural LED driving sections 161 and 162 and the drive switching section 163 are connected to LED1 and LED2. The LED drive controlling section 15 is connected to the LED driving section 16. The LED controlling section 15 supplies the PWM signal to the plural LED driving sections 161 and 162 of the LED driving section 16 and the drive switching section 163 in common respectively. A nonvolatile memory 17 stores an initial value of the PWM value for LED.

Application of the present invention to such scan backlight makes it possible to equalize emission luminance of LED1 and LED2 even if there is a difference in the drive capability between the plurality of LED driving sections 161 and 162. This equalizes the luminance of a parallax image for a left eye and that of a parallax image for a right eye. This allows a high-definition stereoscopic image display to be implemented in the mobile terminal device.

As mentioned above, the present invention can be applied to the liquid crystal display device, which uses PWM dimming to switch the output of the driving section one line by one by the driving section, the liquid crystal display device for a large screen, which switches the output of the driving section every plural lines to offer a blinking backlight for a moving image, and the mobile terminal device having plural power sources for driving.

Although preferred embodiments of the invention have been described with reference to the drawings, it will be obvious to those skilled in the art that various changes or modifications may be made without departing from the true scope of the invention.

1. A lighting device of backlight type that transmits light of a plurality of light emitting elements from a display section, comprising:
a plurality of driving sections that drive the plurality of light emitting elements; and
a drive switching section, provided between the plurality of driving sections and the plurality of light emitting elements, for switching the drive of the plurality of light emitting elements alternately at every fixed cycle.

2. The lighting device according to claim 1, wherein at least one light-off time is provided within one frame time during which one screen is displayed on the display section and the drive of the light emitting elements is switched within the light-off time.

3. The lighting device according to claim 1, wherein the drive switching section controls the switching of the plurality of light emitting elements alternately using a plurality of drive control signals each having a different timing.

4. The lighting device according to claim 3, further comprising switch signal generating section for supplying a switch signal to the drive switching section,
wherein the drive switching section alternately switches the plurality of light emitting elements and the plurality of driving sections respectively to be connected to each other and to adjust an output difference between the plurality of driving sections according to a level change from inactive to active in the drive control signal.

5. The lighting device according to claim 4, wherein the drive switching section comprises a plurality of switches.

6. The lighting device according to claim 1, wherein the plurality of light emitting elements are respectively driven alternately while maintaining a light-on state.

7. The lighting device according to claim 1, wherein the plurality of driving sections drive the plurality of light emitting elements by pulse width modulation (PWM) dimming and the drive switching section switches the drive of the light emitting elements during the light-off time in PWM dimming.

8. A liquid crystal display device comprising:
a liquid crystal display section; and
a lighting device of backlight type that transmits light of a plurality of light emitting elements from the display section, wherein:
a plurality of driving sections that drive the plurality of light emitting elements; and
a drive switching section, provided between the plurality of driving sections and the plurality of light emitting elements, for switching the drive of the plurality of light emitting elements alternately at every fixed cycle are included.

9. The liquid crystal display device according to claim 8, wherein the drive switching section of the lighting device controls the switching of the plurality of light emitting elements alternately by use of a plurality of drive control signals each having a different timing.

10. The liquid crystal display device according to claim 9, further comprising:
a switch signal generating section for supplying a switch signal to the drive switching section of the lighting device,
wherein the drive switching section alternately switches the plurality of light emitting elements and the plurality of driving sections respectively to be connected to each other and to adjust an output difference between the plurality of driving sections according to a level change from inactive to active in the drive control signal.

11. A mobile terminal device comprising:
a liquid crystal display section; and
a lighting device of backlight type that transmits light of a plurality of light emitting elements from a display section, wherein:
a plurality of driving sections that drive the plurality of light emitting elements; and
a drive switching section, provided between the plurality of driving sections and the plurality of light emitting elements, for switching the drive of the plurality of light emitting elements alternately at every fixed cycle are included.

12. The mobile terminal device according to claim 11, wherein the drive switching section of the lighting device controls the switching of the plurality of light emitting elements alternately by use of a plurality of drive control signals each having a different timing.

13. The mobile terminal device according to claim 12, further comprising:
a switch signal generating section for supplying a switch signal to the drive switching section of the lighting device,
wherein the drive switching section alternately switches the plurality of light emitting elements and the plurality of driving sections respectively to be connected to each other and to adjust an output difference between the plurality of driving sections according to a level change from inactive to active in the drive control signal.

14. The mobile terminal device according to claim 13, wherein the drive switching section of the lighting device is a plurality of switches and the switch signal generating section of the lighting device is a switch signal generating section.

15. A method for controlling a lighting device of backlight type that transmits light of a plurality of light emitting elements from a back surface of a display section,
wherein the lighting device comprises a plurality of driving sections that drive the plurality of light emitting elements, a plurality of current switching sections provided between the plurality of driving sections and the plurality of light emitting elements, and a switch signal generating section that supplies a switch signal to the current switching section,
the method comprising the steps of:
alternately switching the plurality of light emitting elements and the plurality of driving sections respectively to be connected to each other by each of the plurality of current switching section according to a level change from inactive to active in the drive control signal; and
causing a sense section to detect light of the light emitting elements lit alternately according to the switching and connection to control the switching of emission of the light emitting elements based on the detection result by the current switching section.

16. The method for controlling the lighting device according to claim 15, further comprising the step of switching the drive of the light emitting elements by the current switching section at a predetermined fixed cycle and within light-off time.

17. The method for controlling the lighting device according to claim 15, further comprising the step of adjusting an output difference between the driving sections of the light emitting elements by switching the light emitting elements alternately according to a switch signal of the plurality of current switching sections each having a different timing.

18. The method for controlling the lighting device according to claim 15, further comprising the luminance unevenness reduction step of adjusting an output difference between the plurality of driving sections by alternately switching the plurality of light emitting elements and the plurality of driving sections to be connected to each other according to a level change from inactive to active in the drive control signal.

19. The method for controlling the lighting device according to claim 15, further comprising the step of adjusting an output difference between the plurality of driving sections by alternately switching the plurality of current switching sections to be connected to the light emitting elements by the plurality of driving sections according to a level change from inactive to active in the drive control signal.

20. The method for controlling the lighting device according to claim 15, further comprising the step of alternately driving each of the plurality of light emitting elements by at least two or more driving sections according to a level change from inactive to active in the drive control signal.

21. The method for controlling the lighting device according to claim 15, further comprising the step of alternately driving each of the plurality of light emitting elements by the driving sections while maintaining a lighting state according to a level change from inactive to active in the drive control signal.
